(19) United States
(12) Patent Application Publication
(10) Pub. No.: US 2010/0126801 A1
(43) Pub. Date: May 27, 2010

(54) Fall arrest apparatus

(76) Inventors: Armand Begin, Calgary (CA); Dennis Begin, Calgary (CA)

Correspondence Address: GOWLING LAFLEUR HENDERSON LLP, SUITE 1400, 700 2ND ST. SW, CALGARY, AB, T2P 4V5, CA

(21) Appl. No.: 12/292,818

(22) Filed: Nov. 26, 2008

(51) Int. Cl. E04G 21/32; A62B 35/00

(52) U.S. Cl. 182/3

(57) ABSTRACT

A fall arrest apparatus for building construction comprises: a base; a support column comprising one or more interconnecting stanchions, the support column having a proximal end mounted to the base; a boom mast having a proximal end rotatably coupled to a distal end of the support column; a boom operable to support a load, the boom having a proximal end coupled to the boom mast such that a distal end of the boom extends away from the boom mast; and a boom support assembly coupled to the boom and the boom mast such that at least a portion of the load is borne by the boom support assembly when the load is applied to the boom.

### FIELD OF INVENTION

The present invention relates to a fall arrest apparatus for building construction.

### BACKGROUND OF THE INVENTION

In typical building construction, workers are required to operate at elevations above ground level. Accidental falls from these elevations can result in severe injury or death. In order to protect workers from such falls, a fall arrest apparatus can be utilized

A number of fall arrest apparatuses are known in the prior art that protect workers from falls at a worksite. One type of fall arrest apparatus comprises a modular system where the height of the apparatus may be incrementally extended as the height of the building advances. This type of apparatus typically contains one or more fixed anchor loops at the top of the apparatus A worker attaches a lanyard to an anchor loop and to a safety harness worn by the worker. The worker may then safely operate in a work environment defined by a radius about the top of the apparatus equal to the length of the lanyard. While this type of apparatus provides the advantage of incremental height extension as the height of the building advances, it has the disadvantage of limiting the worker's safe work environment to a small radius about the top of the apparatus.

Another type of fall arrest apparatus comprises a cable mounted to the side of a building via mounting brackets. A worker attaches a lanyard to the cable and to a safety harness worn by the worker. The worker may then safely operate in a work environment defined by a cylinder along the length of the cable with a radius equal to the length of the lanyard. While this type of apparatus provides the advantage of a larger safe work environment, it has the disadvantage of requiring the apparatus to be remounted to the building whenever the building height advances during construction.

### SUMMARY OF THE INVENTION

It is an objective of the present invention to provide a fall arrest apparatus that overcomes at least some of the disadvantages in the prior art.

According to one aspect of the invention there is provided a fall arrest apparatus for building construction comprising:
(a) a base;
(b) a support column comprising one or more interconnecting stanchions, the support column having a proximal end mounted to the base;
(c) a boom mast having a proximal end rotatably coupled to a distal end of the support column;
(d) a boom operable to support a load, the boom having a proximal end coupled to the boom mast such that a distal end of the boom extends away from the boom mast; and
(e) a boom support assembly coupled to the boom and the boom mast such that at least a portion of the load is borne by the boom support assembly when the load is applied to the boom.

The base may comprise a plate for mounting to a support surface, and a sleeve mounted to the plate and adapted to accept the proximal end of the support column.

The boom may further comprises a fastener mounted to the distal end of the boom, the fastener operable to receive the load. The fastener may be an anchor loop.

The boom may also further comprise a track along the length of the boom, the track operable to receive the load and translate the load along the length of the boom. The track may comprise a stanchion and at least one guide rail spaced from and extending parallel to the stanchion.

The apparatus may be defined such that the proximal end of the boom is coupled to the proximal end of the boom mast, and the boom support assembly comprises a guy-wire coupled to the distal end of the boom and a distal end of the boom mast. The boom support assembly may further comprises a winch mounted to the boom mast, the winch receiving the guy-wire extending from the distal end of the boom mast.

The apparatus may be defined such that the proximal end of the boom is coupled to a distal end of the boom mast, and the boom support assembly comprises a stanchion coupled to the boom and the proximal end of the boom mast.

### BRIEF DESCRIPTION OF THE DRAWINGS

FIG. 1a is a side view of a fall arrest apparatus according to one embodiment of the invention.

FIG. 1b is a side view of the fall arrest apparatus shown in FIG. 1 installed at a worksite.

FIG. 2 is a perspective view of a base of the fall arrest apparatus shown in FIG. 1, shown in isolation.

FIG. 3 is a side view of a stanchion of the fall arrest apparatus shown in FIG. 1, shown in isolation.

FIG. 4 is a side view of a boom mast and a winch of the fall arrest apparatus shown in FIG. 1, shown in isolation.

FIG. 5a is a top view of a boom of the fall arrest apparatus shown in FIG. 1, shown in isolation.

FIG. 5b is a side view of the boom of a fall arrest apparatus according to another embodiment of the invention, shown in isolation.

FIG. 6 is a side view of a fall arrest apparatus according to another embodiment of the invention.

FIG. 7 is a side view of a fall arrest apparatus according to another embodiment of the invention.

### DETAILED DESCRIPTION OF EMBODIMENTS OF THE INVENTION

The embodiments described herein relate to a fall arrest apparatus for building construction. Particularly, the embodiments relate to an apparatus for protecting a worker from falling at a worksite while at the same time permitting the worker to move freely about the worksite.

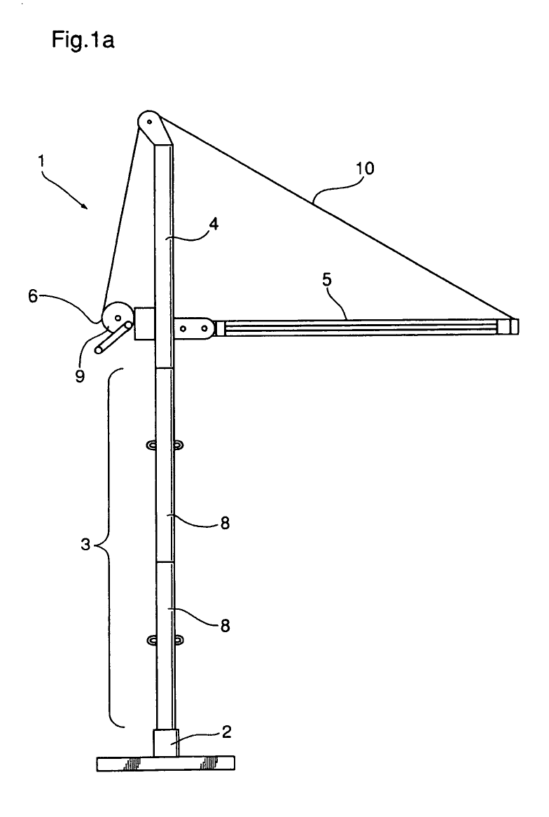

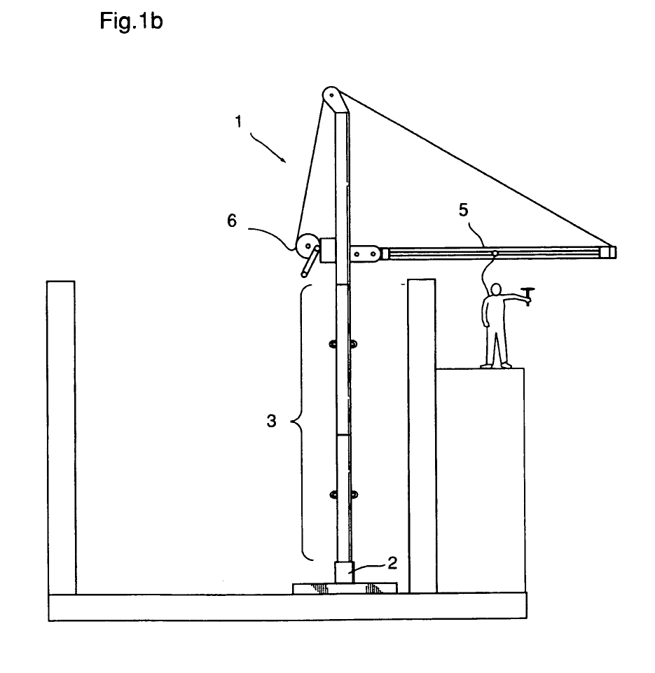

Referring to FIG. 1a, a first embodiment of the fall arrest apparatus is shown generally as item I and comprises the following major components: a base 2, a support column 3, a boom mast 4, a boom 5, and a boom support assembly 6.

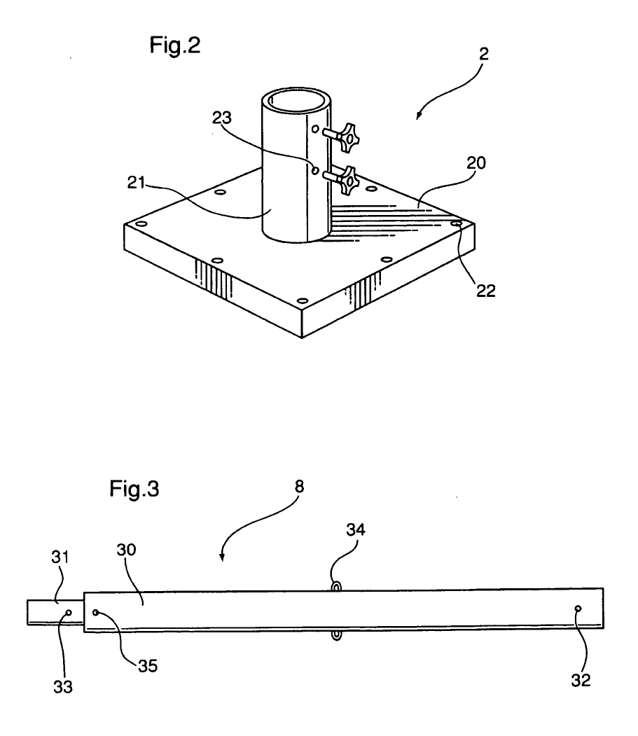

Referring to FIG. 2, the base 2 operates to support the other components of the apparatus 1. During installation, the base 2 is mounted to a support surface (not shown), such as a sub floor of a building under construction. The base 2 comprises a plate 20 and a tubular sleeve 21 mounted to the plate 20 such that the longitudinal axis of the sleeve 21 is perpendicular to the top surface of the plate 20. The plate 20 comprises eight mounting holes 22 about the perimeter of the plate 20 permitting mounting bolts (not shown) to secure the plate 20 to an underlying support surface. The sleeve 21 is sized to receive the proximal end of the support column 3 such that the longitudinal axis of the support column 3 is in axial alignment with the longitudinal axis of the sleeve 21. The sleeve 21 also comprises four mounting holes 23 permitting mounting bolts (not shown) to secure the support column 3 to the base 2 by applying pressure against the outer surface of the support column 3. During assembly of the apparatus 1, the support column 3 is inserted into the sleeve 31 such that the proximal end of the support column 3 rests against the top surface of the plate 20, directing the weight of the apparatus 1 through the plate 20 to the underlying support surface.

In alternative embodiments, the base 2 may comprise other mechanical components and configurations known to one skilled in the art for supporting the apparatus 1. For example, the base 2 may be of sufficient weight such that it is not necessary to mount the base 2 to a supporting surface.

Referring to FIG. 1a, the support column 3 has a proximal end mounted to the base 2 and a distal end rotatably coupled to the boom mast 4. The support column 3 comprises a series of interconnecting stanchions 8. Referring to FIG. 3, each stanchion 8 comprises an outer tube 30 and an inner tube 31. The proximal end of the inner tube 31 is mounted inside of the outer tube 30 by means of two mounting bolts 35, and the distal end of the inner tube 31 extends out of the distal end of the outer tube 30. The inner tube 30 extends inside of the outer tube 30 a longitudinal distance of approximately sixteen inches. During assembly of the apparatus 1, stanchions 8 are stacked in series such that the inner tube 31 of a first stanchion 8 is received by the outer tube 30 of a second stanchion 8 stacked on top of the first stanchion 8. The first and second stanchions 8 are secured to one another by a cotter pin (not shown) inserted through mounting holes 32 in the outer tube 30 of the second stanchion 8 and mounting holes 33 of the inner tube 31 of the first stanchion 8, such that the cotter pin passes through both the first and second stanchions 8. Successive stanchions 8 are stacked in a similar manner.

Each stanchion 8 also comprises four anchor loops 34 mounted to the outer surface of the outer tube 30. During assembly of the apparatus 1, supporting cables can be attached to the anchor loops 34 and to support structures on the worksite in order to provide additional support to the apparatus 1.

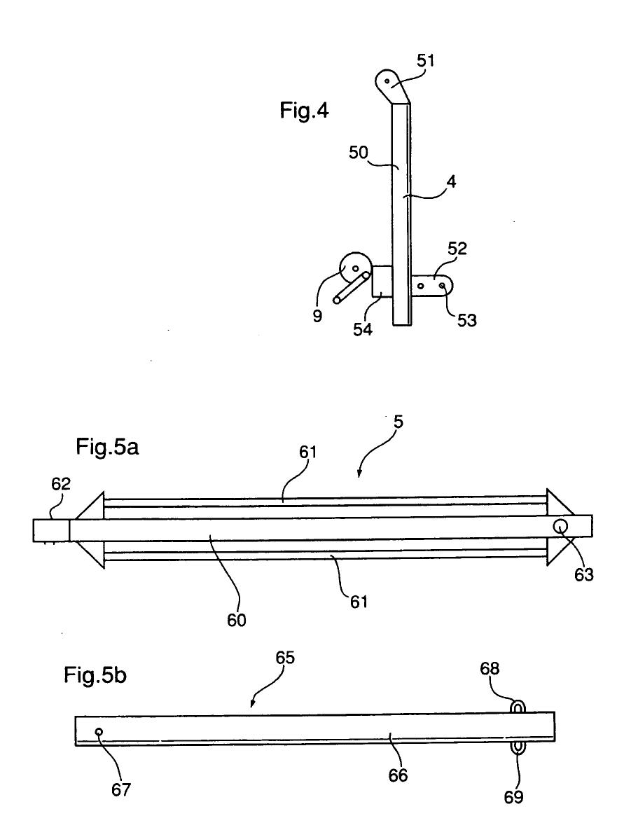

Referring to FIG. 4, the boom mast 4 comprises: a stanchion 50, a pulley 51, a boom mount 52 and a winch mount 53. The stanchion 50 has a distal end mounted to the pulley 51 and a proximal end rotatably coupled to the distal end of the support column 3. The longitudinal axis of the stanchion 50 is in axial alignment with the longitudinal axis of the support column 3, permitting the stanchion 50 to rotate a full 360 degrees about the support column 3. The proximal end of the stanchion 50 comprises a hollow tubular void sized to receive the distal end of the support column 3 inside of the stanchion 50 such that the stanchion 50 is rotatably slidable about the distal end of the support column 3. A bushing is mounted inside the proximal end of the stanchion 50 to reduce rotational friction between the stanchion 50 and the support column 3.

The pulley 51 is mounted to the distal end of the stanchion 50 and is operable to receive a guy-wire 10 forming part of the boom support assembly 6 (described below). The boom mount 52 and the winch mount 54 are mounted to opposite sides of the outer surface of the proximal end of the stanchion 50. The boom mount 52 comprises two flanges each having two mounting holes 53 for mounting to the boom 5 (described below). The winch mount 54 is a rectangular frame mounted to a winch 9 (described below).

Referring to FIG. 1a, the boom S has a proximal end mounted to the boom mast 4 by the boom mount 52 and a distal end coupled to a guy wire 10 (described below). The boom 5 extends out from the boom mast 4 such that the longitudinal axis of the boom 5 is perpendicular to the longitudinal axis of the boom mast 4. In alternative embodiments, the boom 5 may extend in any direction from the boom mast 4.

Referring to FIG. 5a, the boom 5 comprises a track consisting of a stanchion 60 and two retaining rails 61 spaced from and extending generally parallel to the stanchion 60. The proximal end of the stanchion 60 comprises two mounting holes 62 running through the stanchion 60. The spacing between the mounting holes 62 is identical to that of the mounting holes 53 of the boom mount 52, permitting the boom 5 to be bolted to the boom mast 4. The distal end of the stanchion 60 comprises an anchor loop 63 for attachment of the guy-wire 10 (described below).

The retaining rails 61 are mounted to opposite sides of the outer surface of the stanchion 60. In operation, a lanyard is attached around the stanchion 60 and to a safety harness worn by a worker. The retaining rails 61 permit a worker to move the lanyard along the length of the stanchion 60 while restricting the lanyard from moving off of the distal end of the boom 5 such that the lanyard is detached from the stanchion 60.

In alternative embodiments, the track of the base 2 may comprise other mechanical components and configurations known to one skilled in the art operable to receive load and translate the load along the length of the boom 5, for example, a track and rollered trolley system.

Referring to FIG. 5b, an alternative embodiment of a boom 65 comprises a stanchion 66 having mounting holes 67 and an anchor loop 68, identical to those described in boom 5. In addition, the boom 65 comprises an anchor loop 69 mounted to the distal end of the stanchion 66 for accepting a lanyard. In the alternative, any fastener operable to receive a load may be utilized in place of anchor loop 69.

Referring to FIG. 1a, the boom support assembly 6 operates to support the boom 5 when a load is applied to the boom 5. The boom support assembly 6 comprises a winch 9 and the guy-wire 10. The winch 9 is mounted to the winch mount 54. The guy-wire 10 is attached to the anchor loop 63 on the distal end of the boom 5, extends over the pulley 51 of the boom mast 4, and is received by the winch 9. The winch 9 is operable to tighten and loosen the guy-wire 10. It is utilized to place the guy-wire 10 in tension, thereby, transferring a portion of the load on the boom 5 through the guy-wire 10, through the boom mast 4 and support column 3, through the base 2, and to the support surface.

In operation, the apparatus 1 is transported to a worksite in pie-assembled components comprising: the base 2, the stanchions 8, the boom mast 4 attached to the winch 9, the boom 5, the guy-wire 10, and the mounting bolts and cotter pins. The base 2 is mounted to a support surface by bolting the plate 20 of the base 2 to the support surface. The base 2 is typically located on the worksite about the area where the workers will be operating above ground level.

The proximal end of a first stanchion 8 is inserted into and bolted to the sleeve 21 of the base 2. If additional support is required, support cables are attached to a support structure on the worksite and to the anchor loops 34 of the stanchion 8. If additional height is required, the outer tube 30 of a second stanchion 8 is placed over the inner tube 31 of the first stanchion 31. The mounting holes 33 of the first stanchion 8 and the mounting holes 32 of the second stanchion 8 are aligned, and a cotter pin is inserted through the mounting holes 32, 33. This process of stacking and securing stanchions 8 is repeated until a desired height is achieved.

The boom 5 is then bolted to the boom mast 4 by aligning the mounting holes 62 of the boom 5 with the mounting holes 53 of the boom mast 4 and inserting bolts therethrough. The guy wire 10 is attached to the anchor loop 63 of the boom 5, extended over the pulley 51 of the boom mast 4, and received by the winch 9 of the boom support assembly 6. The winch 9 is then operated to place the guy-wire 10 in sufficient tension to bear a portion of a load placed on the boom 5. The boom 5 and boom mast 4 are then elevated and the proximal end of the stanchion 50 of the boom mast 4 is placed over the distal end of the support column 3, such that the boom mast 4, boom 5 and boom mount assembly 6 are rotatable about the support column 3.

A lanyard is attached to the stanchion 60 of the boom 5 and to a harness worn by a worker serving as the load At this point, the worker can safely work above ground level while being free to move along the length of the boom 5 and in a 360 degree path about the support column 3. As the worker moves along the length of the boom 5, the lanyard slidably translates accordingly along the stanchion 60 of the boom 5. As the worker moves in an angular direction about the longitudinal axis of the support column 3, the boom mast 4 and boom 5 rotate accordingly about the same axis.

In the alternative, the boom mast 4 and boom 5 are mounted on the support column in a different sequence. Only one bolt is placed through the boom S and boom mount 53 such that the boom 5 can rotate about the axis of the bolt. The boom 5 is positioned such that the longitudinal axis of the boom 5 is parallel to the longitudinal axis of the boom mast 4. The guy wire 10 is then attached to the anchor loop 63 of the boom 5, extended over the pulley 51 of the boom mast 4, and received by the winch 9 of the boom support assembly 6. The boom 5 and boom mast 4 are then elevated and the proximal end of the stanchion 50 of the boom mast 4 is placed over the distal end of the support column 3, such that the boom mast 4, boom 5 and boom mount assembly 6 are rotatable about the support column 3. The winch 9 is then utilized to rotate the boom 5 about the bolt until the longitudinal axis of the boom 5 is perpendicular with the longitudinal axis of the boom mast 4. A second bolt is placed through the boom 5 and boom mount 53 such that the position of the boom 5 is fixed with respect to the boom mast 4. The winch 9 is then operated to place the guy-wire 10 in sufficient tension to support a load placed on the boom 5.

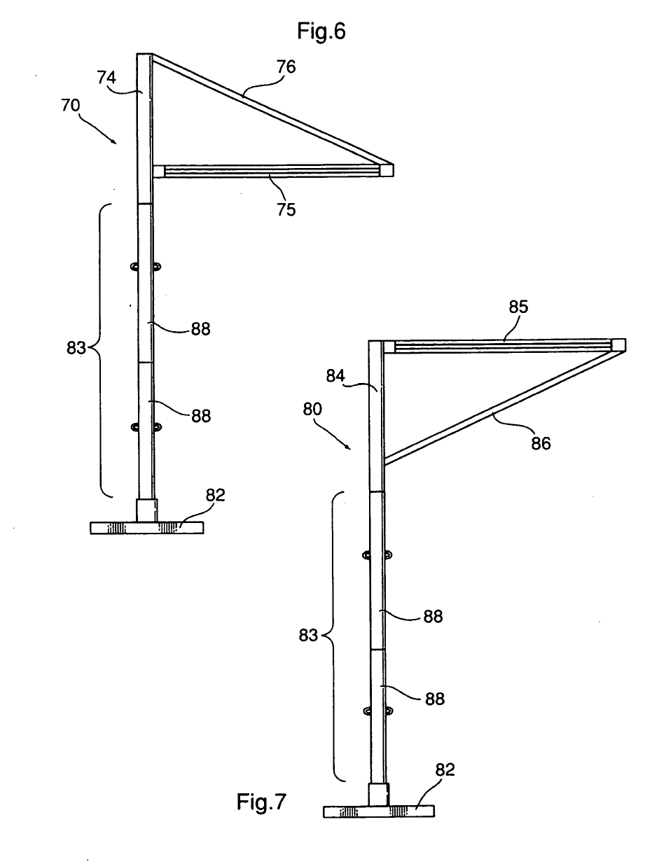

Referring to FIG. 6, an alternative embodiment of a fall arrest apparatus 70 comprises a simplified boom support assembly 76 consisting of a single supporting stanchion. The apparatus 70 also comprises a base 72, support column 73, a boom mast 74, and a boom 75. The base 72 and support column 73 are identical to those described for apparatus 1. The boom mast 74 is identical to boom mast 4, except that boom mast 74 does not comprise a pulley 51 or a winch mount 54. The boom 75 is identical to boom 5, except that the boom 75 does not comprise an anchor loop 63. The boom support assembly 76 consists of a single supporting stanchion that is bolted to the distal end of the boom mast 74 and the distal end of the boom 75. This embodiment offers a more simplistic boom support assembly 76 as compared to the guy-wire 10, pulley 51 and winch 9 disclosed in apparatus 1.

Referring to FIG. 7, an alternative embodiment of a fall arrest apparatus 80 comprises another simplified boom support assembly 86 consisting of a single supporting stanchion. The apparatus 80 also comprises a base 82, support column 83, a boom mast 84, and a boom 85, identical to those described for apparatus 70, except that the proximal end of the boom 85 is mounted to the distal end of boom mast 84, and the boom support assembly 86 is mounted to the distal end of the boom 85 and the proximal end of the boom mast 84. This embodiment also offers a more simplistic boom support assembly 86 as compared to the guy-wire 10, pulley 51 and winch 9 disclosed in apparatus 1.

The embodiments of the present invention described above are merely illustrative and are not to be construed as exhaustive.

We claim:

1. A fall arrest apparatus for building construction comprising:
(a) a base;
(b) a support column comprising one or more interconnecting stanchions, the support column having a proximal end mounted to the base;
(c) a boom mast having a proximal end rotatably coupled to a distal end of the support column;
(d) a boom operable to support a load, the boom having a proximal end coupled to the boom mast such that a distal end of the boom extends away from the boom mast; and
(e) a boom support assembly coupled to the boom and the boom mast such that at least a portion of the load is borne by the boom support assembly when the load is applied to the boom.

2. The apparatus in claim 1, wherein the base comprises:
(a) a plate for mounting to a support surface; and
(b) a sleeve mounted to the plate and adapted to accept the proximal end of the support column.

3. The apparatus in claim 1, wherein the boom further comprises a fastener mounted to the distal end of the boom, the fastener operable to receive the load.

4. The apparatus in claim 3, wherein the fastener is an anchor loop.

5. The apparatus in claim 1, wherein the boom further comprises a track along the length of the boom, the track operable to receive the load and translate the load along the length of the boom.

6. The apparatus in claim 5, wherein the track comprises a stanchion and at least one guide rail spaced from and extending parallel to the stanchion.

7. The apparatus in claim 1, wherein:
(a) the proximal end of the boom is coupled to the proximal end of the boom mast; and
(b) the boom support assembly comprises a guy-wire coupled to the distal end of the boom and a distal end of the boom mast.

8. The apparatus in claim 7, wherein the boom support assembly further comprises a winch mounted to the boom mast, the winch receiving the guy-wire extending from the distal end of the boom mast.

9. The apparatus in claim 1, wherein:
(a) the proximal end of the boom is coupled to a distal end of the boom mast; and
(b) the boom support assembly comprises a stanchion coupled to the boom and the proximal end of the boom mast.
